(19) United States
(12) Patent Application Publication
(10) Pub. No.: US 2018/0137050 A1
(43) Pub. Date: May 17, 2018

(54) LOW POWER MEMORY SUB-SYSTEM USING VARIABLE LENGTH COLUMN COMMAND

(71) Applicant: QUALCOMM Incorporated, San Diego, CA (US)

(72) Inventors: Nikhil JAIN, Dhuri (IN); Ankit SHAMBHU, Bangalore (IN); Shyam Bahadur RAGHUBANSHI, Bangalore (IN); Umesh RAO, Bangalore (IN)

(21) Appl. No.: 15/808,718

(22) Filed: Nov. 9, 2017

Related U.S. Application Data
(60) Provisional application No. 62/420,954, filed on Nov. 11, 2016.

(51) Int. Cl. G06F 12/04; G06F 1/32; G06F 12/1009

(52) U.S. Cl. CPC G06F 12/04; G06F 2212/65; G06F 12/1009; G06F 1/3275

(57) ABSTRACT

Systems and method are directed to reducing power consumption and/or improving performance of a processing system comprising a processor subsystem and a memory subsystem. A variable length column command is used in place of a plurality of column commands directed to a same page of a memory bank of the memory subsystem. The variable length column command is provided to the memory subsystem based on a detection of a plurality of accesses directed to the same page. The memory subsystem, upon receiving a variable length column command, is configured to perform a corresponding plurality of accesses indicated by the variable length column command

### CROSS-REFERENCE TO RELATED APPLICATIONS

The present Application for Patent claims the benefit of Provisional Patent Application No. 62/420,954 entitled “LOW POWER MEMORY SUB-SYSTEM USING VARIABLE LENGTH COLUMN COMMAND” filed Nov. 11, 2016, pending, and assigned to the assignee hereof and hereby expressly incorporated herein by reference in its entirety.

### FIELD OF DISCLOSURE

Disclosed aspects are directed to processing systems. More particularly, exemplary aspects are directed to reducing power consumption and/or improving performance using a variable length column command

### BACKGROUND

Processing systems may include a backing storage location such as a memory subsystem comprising a main memory. For main memory implementations with large storage capacity, e.g., utilizing double-data rate (DDR) implementations of dynamic random access memory (DRAM) technology, the memory subsystem may be implemented off-chip, e.g., integrated on a memory chip which is different from a processor chip or system on chip (SoC) on which one or more processors which access the memory subsystem are integrated.

Power consumption in memory systems is a well-recognized challenge. Several techniques are known in the art for reducing power consumption in memory, such as voltage scaling. For example, the trend in voltage scaling is seen by considering the supply voltages specified in the Joint Electron Device Engineering Council (JEDEC) standard for several generations or versions of low power DDR (LPDDR). The supply voltage VDD is 1.8V for LPDDR1; 1.2V for LPDDR2 and LPDDR3; 1.1V for LPDDR4. However, for future generations (e.g., LPDDR5, and beyond) the scope for further voltage scaling is limited, because if supply voltage continues to reduce, performance degradations may be observed due to limitations imposed by refresh operations and performance of memory peripheral input/output (IO) circuitry. Thus, any power efficiency gains which may be achieved by further voltage scaling may be offset by performance and quality degradations.

In order to reduce the power consumption, a single data rate (SDR) mode was introduced for a command bus for transferring commands and address transactions between the SoC and the memory subsystem since the command bus was seen to utilize lower bandwidth in comparison to data buses. However, in the SDR mode, the bandwidth utilization of the command bus is seen to be on the rise, for example in the case of applications such as gaming, video playback, and other multimedia applications which utilize large data transfers between masters or processors such as graphics processing units (GPUs) or multimedia controllers on the SoC and the DRAM. This is because in conventional implementations, a separate column command is sent for each transfer of a data block (e.g., 16 or 32 bytes for DDR devices supporting ×8 data interfaces; or 32 or 64 bytes for DDR devices supporting ×16 data interfaces) from the SoC to the DRAM in the memory subsystem. However, the total amount of data transferred in such applications may be of much larger sizes, e.g., spanning entire and sometimes multiple rows or pages, even though the column commands are sent for each of the smaller data block sizes.

Thus, it is seen that conventional implementations may involve a large number of column commands transferred from the SoC to the memory subsystem, with a plurality of column commands directed to different columns within the same row or page of a bank of the DRAM. The plurality of column commands transferred between the SoC and the memory subsystem lead to increased power consumption or redundancy of column commands for read/write operations. Particularly as the industry adopts newer standards such as LPDDR5 and beyond, which are designed to support speeds in the range of 3.2 to 4 GHz, the power consumption due to the increased transfer of the plurality of column commands starts to play a more significant role.

Since there is an ever increasing need to reduce power consumption in processing systems, particularly at advanced technology nodes (e.g., 7 nm technologies which may be seen for systems such as Internet-of-Things and other connected devices which adopt the newer generations of DRAM such as LPDDR5), there is also seen to be a corresponding need to reduce the power consumption of the command bus between the SoC and the memory subsystem.

### SUMMARY

Exemplary aspects of the invention include systems and methods directed to reducing power consumption and/or improving performance of a processing system comprising a processor subsystem or SoC and a memory subsystem comprising memory such as a DRAM. In some aspects, variable length column commands are used in place of a plurality of column commands directed to a same row or page of a memory bank of the DRAM, for example. The variable length column commands are provided by the SoC based on a detection of a plurality of accesses directed to the same row or page. The memory subsystem, upon receiving a variable length column command, is configured to perform a corresponding plurality of accesses indicated by the variable length column command Transferring the variable length column command on a command bus between the SoC and the memory subsystem consumes less power in comparison to a corresponding transfer of the plurality of column commands Furthermore, transfer of the variable length column command for a particular row or page of a memory bank reduces a time duration before which a subsequent command can be transferred, for example, to a different memory bank, which improves performance

### BRIEF DESCRIPTION OF THE DRAWINGS

The accompanying drawings are presented to aid in the description of aspects of the invention and are provided solely for illustration of the aspects and not limitation thereof.

FIGS. 1A-C illustrate aspects of a conventional processing system.

FIGS. 2A-D illustrate implementations of a variable length column command in an exemplary processing system, according to exemplary aspects of this disclosure.

FIGS. 3A-E illustrate contrasts in implementations of a command sequence in a conventional processing system and an exemplary processing system configured according to exemplary aspects of this disclosure.

FIG. 4 illustrates a flow chart pertaining to implementation of a variable length column command in a memory subsystem according to exemplary aspects of this disclosure.

FIG. 5 is a block diagram showing an exemplary wireless communication system in which aspects of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to reducing power consumption in a processing system comprising a processor subsystem or SoC and a memory subsystem comprising memory such as a DRAM. In some aspects, variable length column commands are used in place of a plurality of column commands directed to a same row or page of a memory bank of the DRAM, for example. The variable length column commands are provided by the SoC based on a detection of a plurality of accesses directed to the same row or page. The memory subsystem, upon receiving a variable length column command, is configured to perform a corresponding plurality of accesses indicated by the variable length column command Transferring the variable length column command on a command bus between the SoC and the memory subsystem consumes less power than the transfer of the plurality of column commands Furthermore, transfer of the variable length column command for a particular row or page of a memory bank reduces a time duration before which a subsequent command can be transferred, for example, to a different memory bank. Thus, performance improvements may also be realized in the exemplary use of the variable length column command.

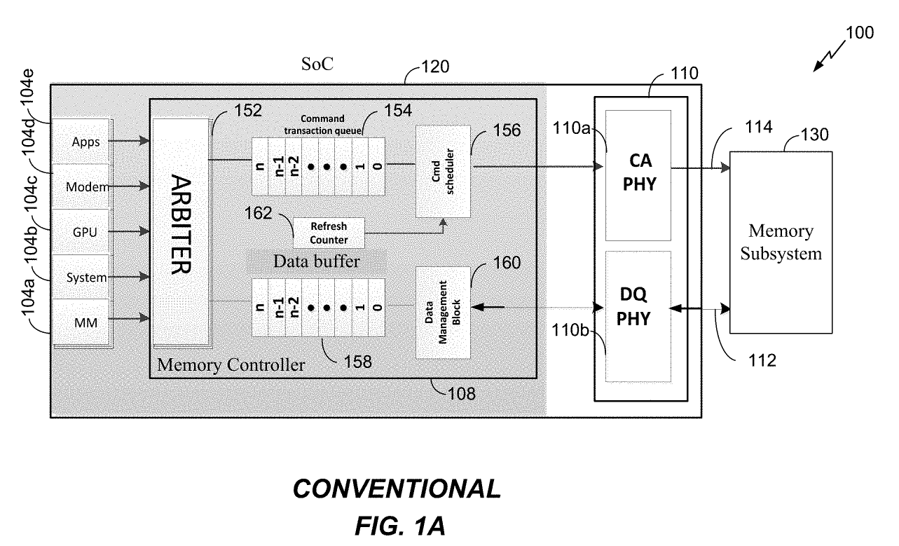

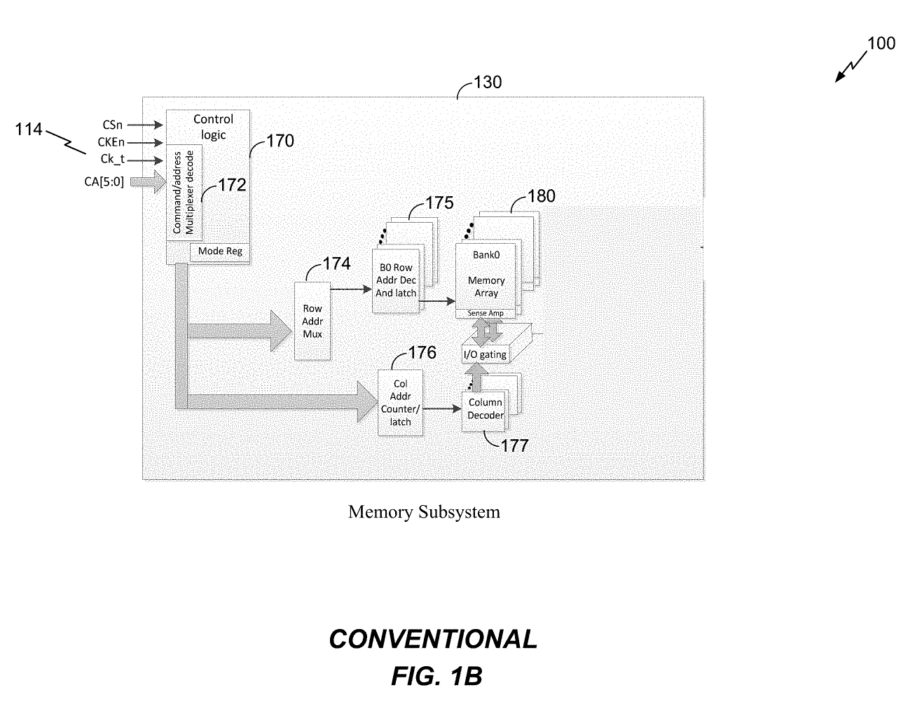

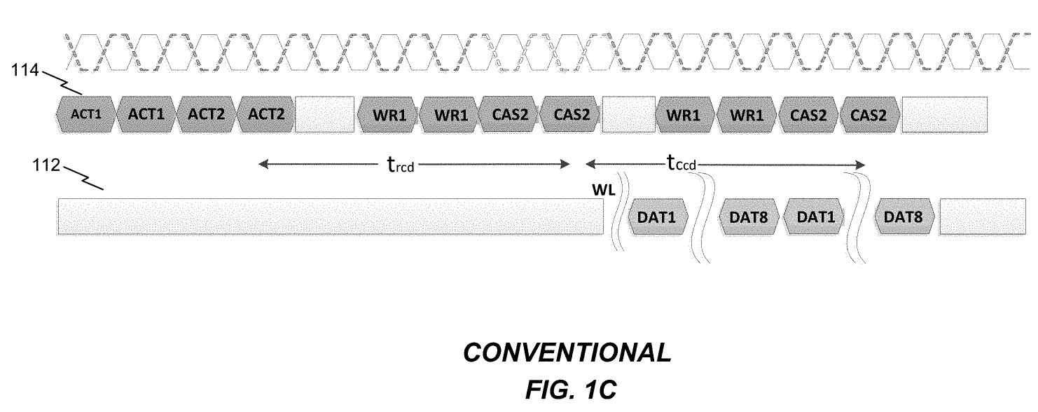

In FIG. 1A, a conventional processing system 100 is illustrated with system on chip (SoC) 120 coupled to memory subsystem 130 (shown in greater detail in FIG. 1B). SoC 120 can comprise one or more processing elements of which, for the sake of an exemplary illustration, processing elements 104a-e are representatively shown as multimedia (MM) processor 104a, system processor 104b, graphics processing unit (GPU) 104c, modulator-demodulator (modem) 104d, and applications processor 104e. Various other processors or processing elements such as a digital signal processor, a multi-core central processing unit (CPU), etc., may also be present even though not explicitly illustrated. Processing elements 104a-e may be connected to memory controller 108. Processing elements 104a-e may make requests for accessing one or more banks of memory in memory subsystem 130, and memory controller 108 controls these access requests. For example, memory controller 108 may include arbiter 152 to arbitrate among the various requests received from processing elements 104a-e and queue them in command transaction queue 154, for example. Command scheduler 156 may select from the transactions in command transaction queue 154 to grant memory access to one or more of the outstanding requests, for example, each clock cycle.

Additionally, in the case of DRAM in memory subsystem 130, periodic refresh of memory cells is required, as known in the art, and refresh counter 162 may provide periodic messages to command scheduler 156 to provide refresh commands to memory subsystem 130. The transactions from command scheduler 156 are transferred to memory interface 110 which may include a physical layer module for commands shown as CA PHY block 110a. Corresponding data to be transferred for some requests (e.g., write commands) is queued in data buffer 158, and with the control of data management block 160 for selected transactions, the data is provided to a physical layer module for data shown as DQ PHY block 110b in memory interface 110. Data received from memory subsystem 130 (e.g., read data), via DQ PHY block 110b and data management block 160 may also be placed in the same data buffer 158 or a different data buffer, per particular implementations, before being provided to a requesting processing element 104a-e. Various other control logic and functional blocks may be present in memory controller 108 and more generally, SoC 120, but these are not germane to this disclosure, and as such are not dealt with in further detail herein.

Two buses are shown for transferring commands and data between SoC 120 and memory subsystem 130—command bus (also referred to as CA) 114 for transferring addresses, commands, etc., from SoC 120 to memory subsystem 130 and data bus (also referred to as DQ) 112, which may be a bidirectional bus for transferring write data from SoC 120 to memory subsystem 130 and receiving read data at SoC 120 from memory subsystem 130.

Referring now to FIG. 1B, a conventional implementation of memory subsystem 130 is shown in greater detail. Memory subsystem 130 may include DRAM with a plurality of memory banks collectively shown by the reference numeral 180. Each memory bank 180 may be arranged as a memory array with a plurality of rows and a plurality of columns. In DRAM technology, a row is also referred to as a page. Each row or page (which may be 2 KB, for example) may comprise a plurality of data blocks (e.g., of 16 or 32 bytes, spanning a corresponding number of columns). A write command, for example received via CA bus 114 may include, among other components, a command address shown as CA [5:0], which is decoded by command address decoder 172 of control logic 170 to provide a column address to latch 176 for a targeted data block. Column decoder 177 selects the specific columns to be accessed for the targeted data block. Correspondingly, row address multiplexor 174 provides the row or page address of a targeted memory bank 180 to be activated for a particular command to row address decoder and latch 175. In a conventional implementation, each data block of a page is written in an individual transaction in the above-described manner. Various other components of memory subsystem 130 which may be present (e.g., read latches, write data FIFOs, etc.) which are not particularly relevant to this disclosure are omitted from the discussion herein for the sake of brevity.

With combined reference now to FIGS. 1A-B, in selecting from the outstanding requests in command transaction queue 154, command scheduler 156 may apply various policies, algorithms, reordering of command transaction queue 154, etc., for prioritizing some requests over others, rather than always following a first-in-first-out type of an approach, for example. In one example, command scheduler 156 may apply, among other policies, an “open page policy,” wherein if a target page (or row) of a memory bank 180 has been opened to service a previous or current request, then an outstanding request which is directed to the open page may be favored. This way, the open page may be accessed for servicing more than access request before being closed. For memory access requests which exhibit spatial locality, i.e., are likely to have target addresses within the same page of a memory bank, the open page policy may improve performance and also power efficiency because repetitive and power hungry opening (activation) and closing of pages may be reduced.

Each page of the memory bank 180 may comprise several data blocks, for example, of bit lengths 16 or 32 bytes each. In a conventional implementation, a write operation to a page of the memory bank is provided in terms of a column command for each data block to be written. With an open page policy, if a plurality of data blocks is targeted, a corresponding plurality of column commands is selected by command scheduler 156 and provided back to back (also referred to as a burst of column commands)

For example, with combined reference to FIGS. 1A and 1C, a burst of column commands sent on CA bus 114 between SoC 120 and memory subsystem 130 is shown. Specifically, to perform a write operation, a particular memory bank targeted is first activated by sending activate commands shown as ACT1 and ACT2 commands Subsequently write commands (e.g., for two cycles) are sent, shown as WR1 repeated for two cycles, followed by corresponding column commands shown as CAS2 repeated for two cycles, for writing each data block, e.g., DAT1-DAT8 sent on DQ bus 112. The write commands and column commands are repeated for each data block (e.g., a plurality of data blocks within the same page) targeted by a burst of column commands Each one of these plurality of column commands (e.g., WR1 commands followed by CAS2 commands) consumes power, not only on the CA bus 114, but also for the accompanying circuitry shown and described in FIGS. 1A-B for SoC 120 and memory subsystem 130.

In order to reduce the above power consumption, in exemplary aspects, a variable length column command is disclosed. In place of a burst of a plurality of conventional column commands, each directed to an individual data block of the same page of a memory bank, the variable length column command may be used to direct write operations to a plurality of the data blocks targeted by the plurality of column commands In exemplary aspects, the variable length column command consumes less power, both for transfer on the CA bus 114, as well as corresponding circuitry on the SoC and the memory subsystem in comparison to the plurality of column commands which are used to accomplish the same task in conventional processing system 100.

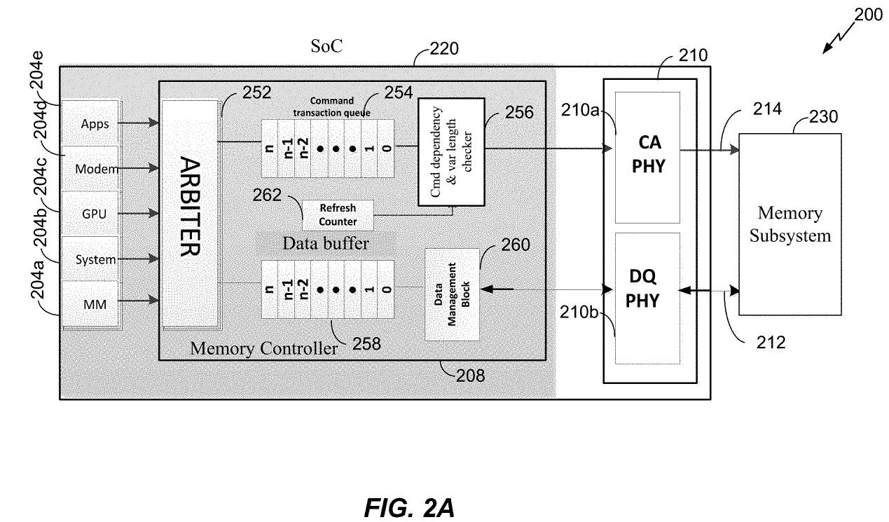

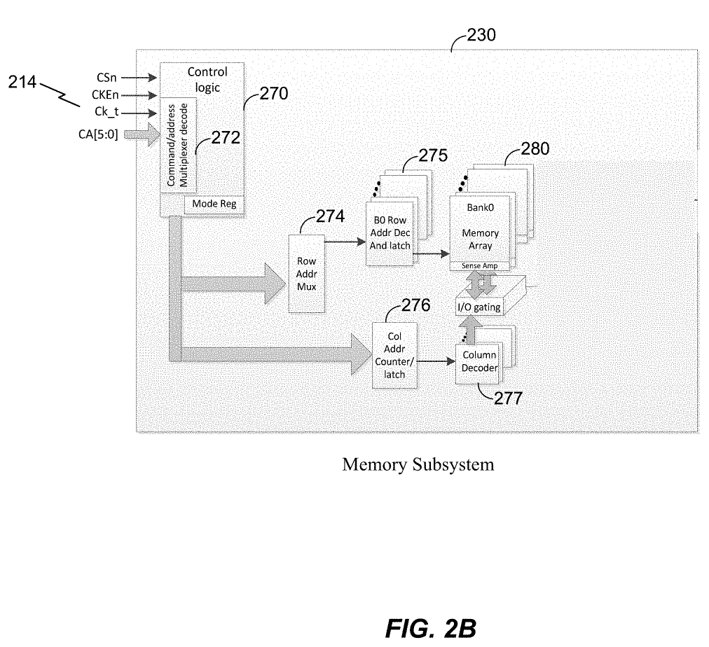

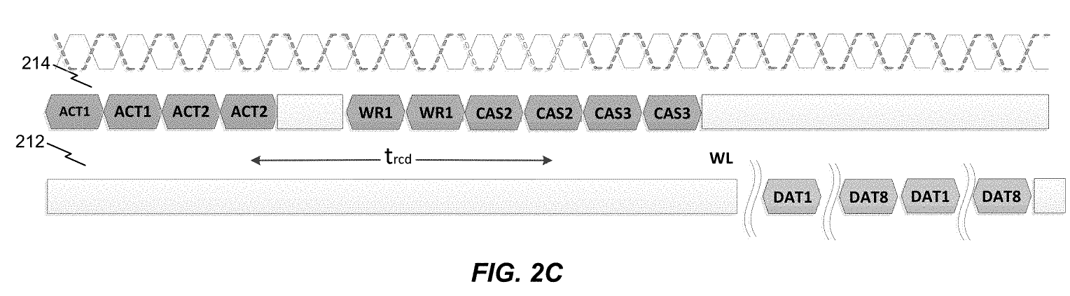

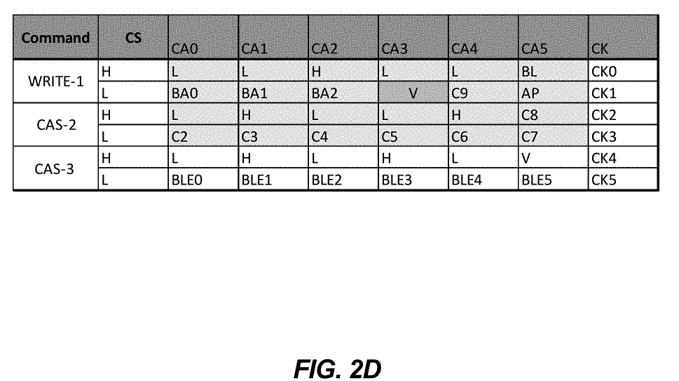

With reference to FIG. 2A, exemplary processing system 200 configured to implement the exemplary variable length column command is shown. Some components of processing system 200 may be similarly configured as the components of processing system 100 discussed above and therefore exhaustive details of the similar components will not be repeated for the sake of brevity. Rather, the following discussion will be predominantly directed to the exemplary features involving the variable length column command in processing system 200.

As such, processing system 200 is shown to comprise SoC 220 and memory subsystem 230, with processing elements 204a-e (which may be similar to counterpart processing elements 104a-e of FIG. 1A). SoC 220 is shown to comprise memory controller 208, wherein memory controller 208 comprises arbiter 252, command transaction queue 254, refresh counter 262, data buffer 258, and data management block 260, which may have some similar functionalities as arbiter 152, command transaction queue 154, refresh counter 162, data buffer 158, and data management block 160, respectively, of FIG. 1A. In one aspect, command dependency and variable length checker 256 may be configured according to exemplary aspects as follows.

Command dependency and variable length checker 256 may be configured to check for dependencies in command transaction queue 254, such as for two or more commands which may be directed to the same page of the same memory bank, but to different data blocks, and more specifically, adjacent data blocks in some aspects. If such dependencies are found, the two or more commands are replaced by the exemplary variable length column command, an example format of which will be discussed with reference to FIGS. 2C-D.

The variable length column command, when generated in place of the two or more commands by command dependency and variable length checker 256, may be provided to CA PHY block 210a of memory interface 210 to be transferred on CA bus 214 to memory subsystem 230. The remaining aspects such as DQ bus 212 and DQ PHY block 210b may be similarly configured as DQ bus 112 and DQ PHY block 110b and as such, will not be discussed in further detail herein.

Referring now to FIG. 2B, memory subsystem 230 is shown, which may be configured to support the variable length column command received on CA bus 214. In memory subsystem 230, memory banks 280, row address multiplexor 274, and row address decoder and latch 275 may be similar to memory banks 180, row address multiplexor 174, and row address decoder and latch 175 of FIG. 1A in some aspects. However, control logic 270 may be configured according to exemplary aspects to accommodate command address multiplexor and decoder 272 configured to decode the variable length column command In one example, the variable length column command may provide a burst length extension for two or more column addresses to also be accessed, and command address multiplexor and decoder 272 may include a counter to increment the column addresses to be provided for activating the multiple data blocks specified by the burst length extension. Correspondingly, column address counter/latch 276 may, upon receipt of the column addresses for the multiple data blocks to be activated, activate the corresponding column addresses through column decoder 277, for servicing the variable length column command In other words, upon receipt of the variable length column command, the logic associated with the counter, for example, can enable access to multiple column addresses (a process which would otherwise have required separate column commands in conventional implementations). Accordingly, the multiple data blocks may be serviced based upon the single variable length column command in exemplary aspects.

With combined reference now to FIGS. 2A-C, an example command sequence for using the variable length column address is shown. Subsequent activation of the intended memory bank of memory banks 280 using the ACT1 and ACT2 commands is as follows. In FIG. 2C, a single write command sequence is provided, comprising the two cycle WR1 commands, two cycle CAS2 commands, and two cycle CAS3 commands From activation to the CAS commands, there may be a time period or time delay referred to as RAS-to-CAS delay (t_{red}) in DRAM terminology. The command CAS3 may have a format which is described in FIG. 2D. When command address multiplexor and decoder 272 observes the CAS3 command format, command address multiplexor and decoder 272 is configured to recognize that the exemplary variable length column command has been provided and a burst length extension is derived from the CAS3 command A counter, as previously mentioned, may then increment the column addresses based on the burst length extension and data block size. Correspondingly, multiple sets of data blocks DAT1-DAT8 are sent on DQ bus 212 to be written to the targeted memory bank 280 using the single sequence comprising the two cycle WR1, CAS2, CAS3 commands (rather than the multiple (two cycle) commands WR1, CAS2 used in the conventional implementation discussed in FIG. 1C to achieve the same effect).

Referring to FIG. 2D, the sample format for the exemplary CAS3 command is shown. The bit in position 3 of CA[5:0] or CA[3] is set to valid (or “1”) for the variable length column command, whereas the CA[3] bit in CA bus 214 is not set (or set to “0”) for conventional column address commands (e.g., CAS2). A corresponding burst length extension (BLE) field is also provided with a value, e.g., 0-63, when CA[3] is valid for the CAS3 command In an example, a burst length extension of 63 provides the maximum of 64 possible values using 6 bits, i.e., 64, and with a data block size of 32 bytes, provides a column command to access 64*32 bytes=2 KB, which may be the entire page size. Thus, in one example, with a single variable length column command, an entire page may be targeted, which can replace 64 individual column address commands (e.g., conventional CAS2 commands) which can accomplish the same effect in conventional implementations.

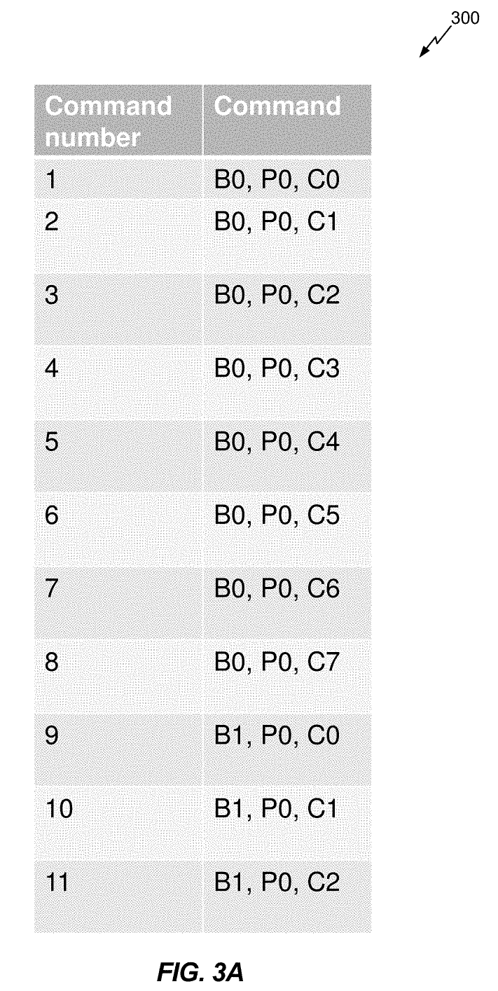

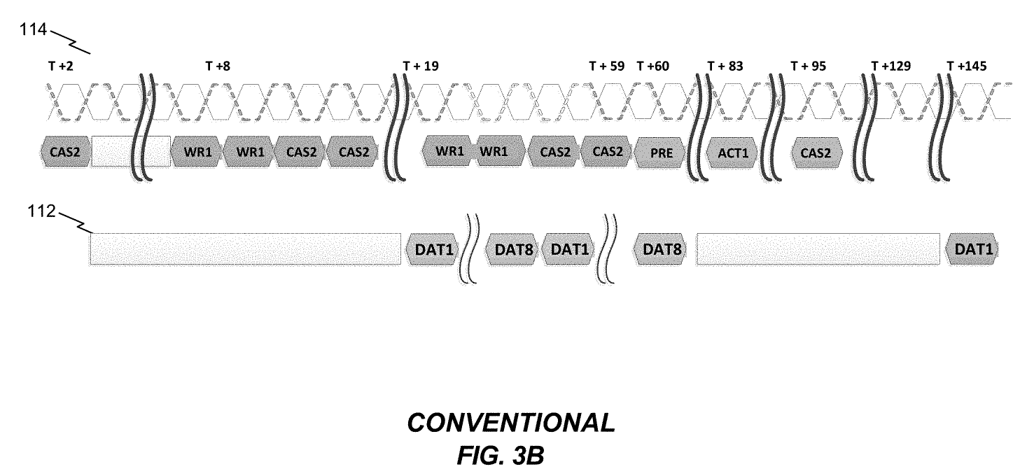

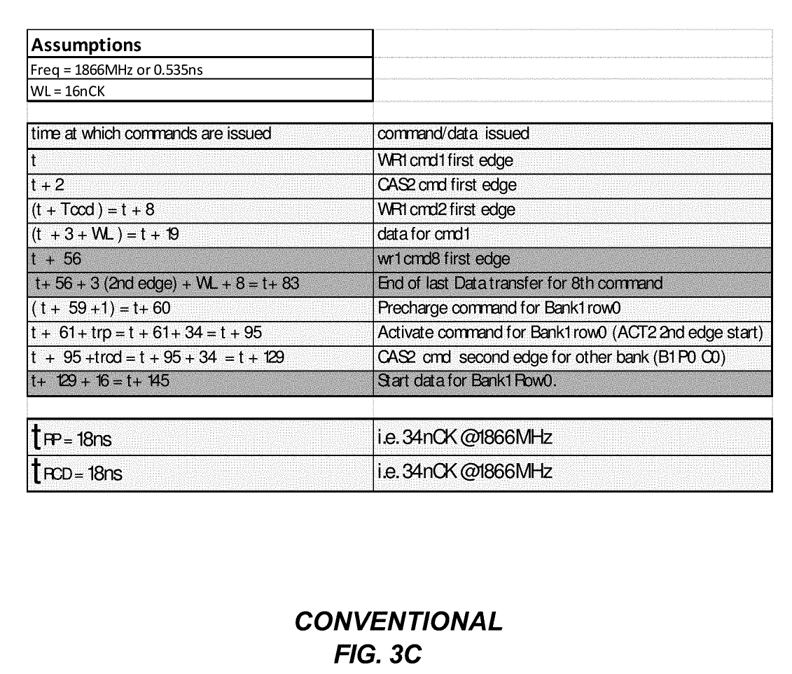

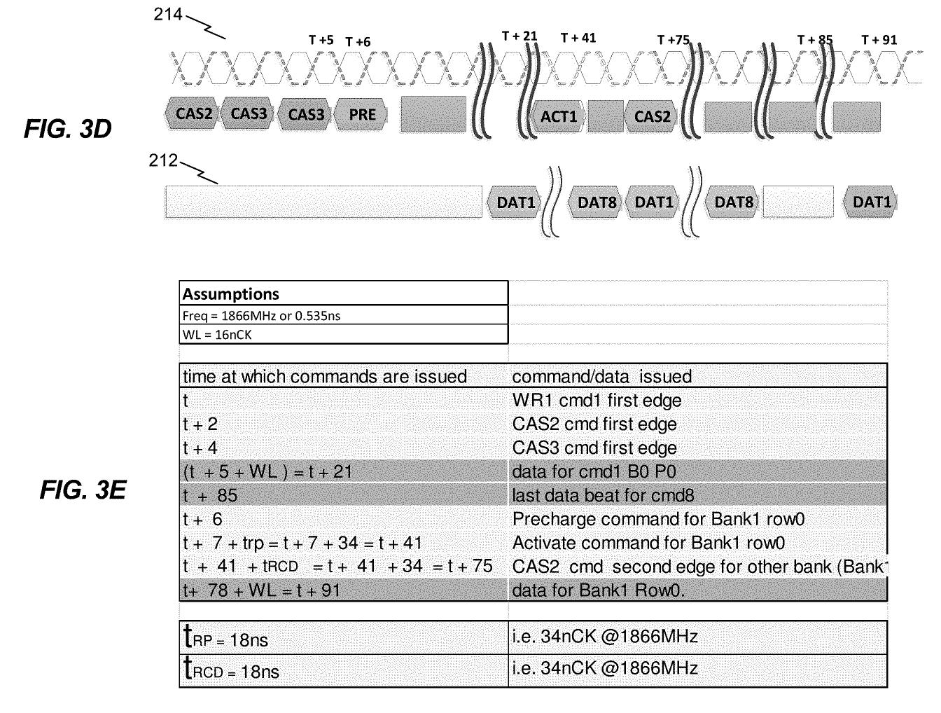

With reference now to FIG. 3A, an example command sequence 300 is shown for accessing data blocks of multiple memory banks, to demonstrate yet another aspect of the exemplary variable length column command Specifically, commands 1-8 of command sequence 300 are directed to data blocks corresponding to column addresses C0-C7 of row 0 (P0) of memory bank B0, and commands 9-11 are directed to data blocks corresponding to column addresses C0-C2 in row 0 (P0) of another memory bank B1.

Referring to FIGS. 3B-C, a conventional implementation of command sequence 300, e.g., in processing system 100 over CA bus 114 is shown. A timeline is illustrated in FIG. 3B with reference to an arbitrary time instance T to show the progression of commands 1-11 in command sequence 300 over CA bus 114, with details of the timeline and accompanying assumptions shown in FIG. 3C. As can be observed with a combined reference to FIGS. 3B-C, after commands 1-8 directed to memory bank B0 are sent out, a pre-charge sequence is initiated for memory bank B1 before memory bank B1 can be activated. Specifically, after the leading edge of the last write command, command 8, for memory bank B0 is issued at time t+56; a corresponding transfer of the last data block for this command 8 occurs at time t+83 on data DQ bus 112. However the pre-charge command for memory bank B1 can only be issued after the trailing edge of command 8, i.e., at time t+60. The command sequence for memory bank B1 may be initiated subsequently, with transfer of data on DQ bus 112 for memory bank B1, row 0 following command 9 being initiated at time t+145. Thus it is seen that after the last data block for command 8 occurs at time t+83, there is a time delay of 62 clock cycles until time t+145 when data transfer for memory bank B1, row 0 is commenced, during which DQ bus 112 remains idle. This is a required time that DQ bus 112 must remain idle based on the conventional implementations for DRAM using the traditional CAS2 column command for each one of commands 1-11.

In contrast, FIGS. 3D-E show an exemplary implementation of command sequence 300, e.g., in processing system 200 over CA bus 214 using the variable length column command A timeline is illustrated in FIG. 3D, once again with reference to an arbitrary time instance T to show the progression of commands 1-11 in command sequence 300 over CA bus 214, with details of the timeline and accompanying assumptions shown in FIG. 3D. As can be observed with a combined reference to FIGS. 3D-E, a single variable length column command directed to memory bank B0 using CAS3 may replace the traditional implementation of sending each one of commands 1-8 separately. This means that corresponding data transfer on DQ bus 212 can start at time t+21 following command 1 and continue till time t+85; but the commands for precharging memory bank B1 may commence at time t+6 directly after command 1 has been sent out without waiting for time t+85 when the data transfer ends for memory bank B0.

Correspondingly, memory bank B1 will be precharged by the time the data transfer to memory bank B0 ends at time t+85, which means that the data transfer on DQ bus 112 to memory bank B1 can commence as early as time t+91, providing a mere 6 cycle clock delay from when the data transfer for memory bank B0 ended (as contrasted with the 62 cycle wait time during which DQ bus 112 must remain idle for conventional implementations of command sequence 300).

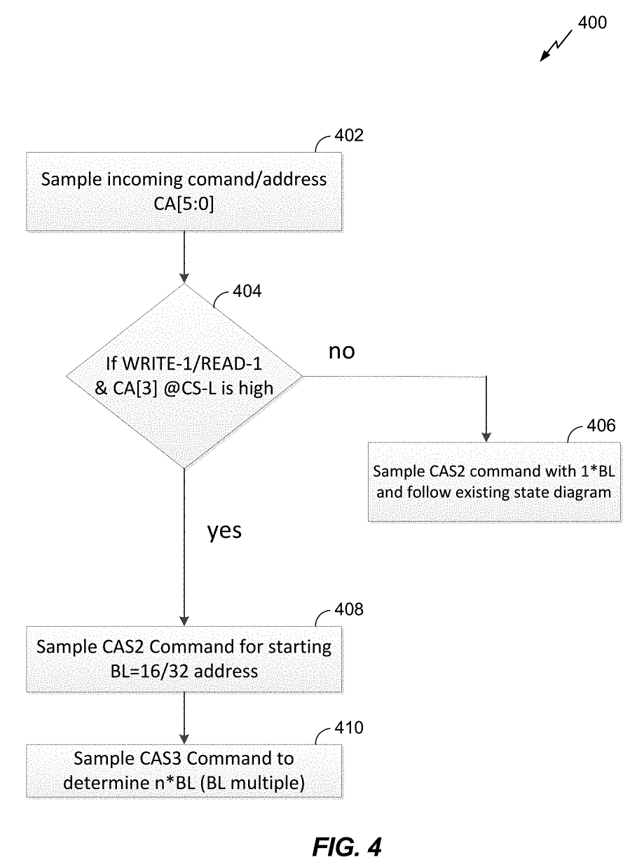

It will be appreciated that aspects include various methods for performing the processes, functions and/or algorithms disclosed herein. FIG. 4 illustrates an example method 400 for implementing a variable length column command received at memory subsystem 230.

For example, in block 402, the column address CA[5:0] received on CA bus 214 is decoded by command address multiplexor and decoder 272, e.g., to determine whether CA[3] is set.

In block 404, command address multiplexor and decoder 272 may determine the operation is for a conventional write or a conventional read and whether CA[3] is set at the sampling time, i.e., when CS-L is high (see FIG. 2D).

If the outcome of the determination in block 404 is no, then in block 406, the command CAS2 may be sampled and method 400 may return to conventional processing using CAS2 commands

If the outcome of the determination in block 404 is yes, then in block 408, command address multiplexor and decoder 272 may extract information pertaining to the starting column address for performing the variable length column command and in block 410, determine the block length extension or number of data blocks for which the corresponding memory bank is to be accessed continuously.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for reducing power consumption in a processing system using a variable length column command. Accordingly, the invention is not limited to illustrated examples and any means for performing the functionality described herein are included in aspects of the invention.

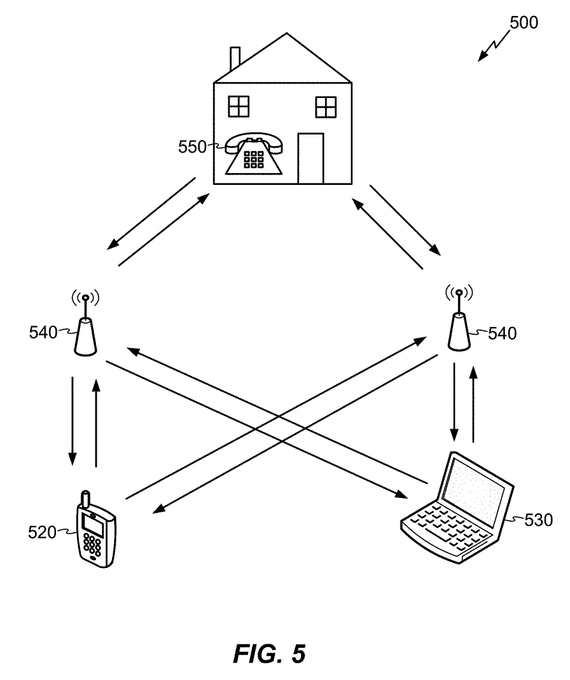

FIG. 5 illustrates an exemplary wireless communication system 500 in which an aspect of the disclosure may be advantageously employed. For purposes of illustration, FIG. 5 shows three remote units 520, 530, and 550 and two base stations 540. In FIG. 5, remote unit 520 is shown as a mobile telephone, remote unit 530 is shown as a portable computer, and remote unit 550 is shown as a fixed location remote unit in a wireless local loop system. For example, the remote units may be integrated into a set top box, a server, a music player, a video player, an entertainment unit, a navigation device, a personal digital assistant (PDA), a fixed location data unit, a computer, a laptop, a tablet, a communications device, a mobile phone, or other similar devices. Although FIG. 5 illustrates remote units according to the teachings of the disclosure, the disclosure is not limited to these exemplary illustrated units. Aspects of the disclosure may be suitably employed in any device which includes active integrated circuitry including memory and on-chip circuitry for test and characterization.

The foregoing disclosed devices and methods are typically designed and are configured into GDSII and GERBER computer files, stored on a computer-readable media. These files are in turn provided to fabrication handlers who fabricate devices based on these files. The resulting products are semiconductor wafers that are then cut into semiconductor die and packaged into a semiconductor chip. The chips are then employed in devices described above.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of performing memory accesses, the method comprising:
receiving a variable length column command at a memory subsystem from a processor subsystem;
determining, from the variable length column command, a number of two or more data blocks of a memory bank of the memory subsystem to be accessed; and
continuously accessing the number of two or more data blocks of the memory bank in response to the variable length column command

2. The method of claim 1, wherein the two or more data blocks are adjacent to one another.

3. The method of claim 1, wherein the two or more data blocks are part of a same page of the memory bank.

4. The method of claim 1, wherein the variable length column command is provided by the processor subsystem to replace two or more column commands directed to accessing the two or more data blocks.

5. The method of claim 1, further comprising determining from the variable length column command, a burst length extension indicating the two or more data blocks to be accessed.

6. The method of claim 5, further comprising incrementing a counter for determining column addresses corresponding to the two or more data blocks based on the burst length extension and sizes of the two or more data blocks.

7. The method of claim 1, further comprising closing one or more of the two or more data blocks which were activated based on the variable length column command before the variable length column command is fully received by the memory subsystem.

8. The method of claim 1, wherein the memory subsystem comprises a dynamic random access memory (DRAM).

9. An apparatus comprising:
a memory subsystem, wherein the memory subsystem comprises:
a command address multiplexor and decoder configured to receive a variable length column command from a processor subsystem, and determine, from the variable length column command, a number of two or more data blocks of a memory bank of the memory subsystem to be accessed; and
logic configured to continuously access the number of two or more data blocks of the memory bank in response to the variable length column command.

10. The apparatus of claim 9, wherein the two or more data blocks are adjacent to one another.

11. The apparatus of claim 9, wherein the two or more data blocks are part of a same page of the memory bank.

12. The apparatus of claim 9, wherein the variable length column command is provided by the processor subsystem to replace two or more column commands directed to access of the two or more data blocks.

13. The apparatus of claim 9, wherein the command address multiplexor and decoder is further configured to determine, from the variable length column command, a burst length extension configured to indicate the two or more data blocks to be accessed.

14. The apparatus of claim 13, wherein the command address multiplexor and decoder further comprises a counter, wherein the counter is configured to increment column addresses corresponding to the two or more data blocks based on the burst length extension and sizes of the two or more data blocks.

15. The apparatus of claim 9, wherein the memory subsystem further comprises logic configured to close one or more of the two or more data blocks which were activated based on the variable length column command before the variable length column command is fully received at the memory subsystem.

16. The apparatus of claim 9, integrated into a device selected from the group consisting of a set top box, a server, a music player, a video player, an entertainment unit, a navigation device, a personal digital assistant (PDA), a fixed location data unit, a computer, a laptop, a tablet, a communications device, and a mobile phone.

17. An apparatus comprising:
means for receiving a variable length column command at a memory subsystem from a processor subsystem;
means for determining, from the variable length column command, a number of two or more data blocks of a memory bank of the memory subsystem to be accessed; and
means for continuously accessing the number of two or more data blocks of the memory bank in response to the variable length column command

18. The apparatus of claim 17, wherein the two or more data blocks are adjacent to one another.

19. The apparatus of claim 17, wherein the two or more data blocks are part of a same page of the memory bank.

20. The apparatus of claim 17, wherein the variable length column command is provided by the processor subsystem to replace two or more column commands directed to accessing the two or more data blocks.

21. The apparatus of claim 17, further comprising means for determining from the variable length column command, a burst length extension indicating the two or more data blocks to be accessed.

22. The apparatus of claim 21, further comprising means for determining column addresses corresponding to the two or more data blocks based on the burst length extension and sizes of the two or more data blocks.

23. The apparatus of claim 21, further comprising means for closing one or more of the two or more data blocks which were activated based on the variable length column command before the variable length column command is fully received by the memory subsystem.

24. A method of performing memory accesses, the method comprising:
determining, in a memory controller of a processor subsystem, that two or more column commands for accessing a memory subsystem are directed to two or more data blocks of a same page of a memory bank; and
for the two or more column commands directed to the two or more data blocks of the same page of the memory bank, replacing the two or more column commands with a variable length command for continuously accessing the two or more data blocks of the same page.

25. The method of claim 24, further comprising determining that the two or more column commands for accessing a memory subsystem are directed to the two or more data blocks of the same page of the memory bank based on checking dependencies in a command transaction queue in the memory controller.

26. The method of claim 24, wherein the two or more data blocks are at least one of: adjacent to one another or belong to a same page of the memory bank.

27. The method of claim 24, further comprising providing in the variable length command, a burst length extension indicating the two or more data blocks to be accessed.

28. The method of claim 27, wherein column addresses corresponding to the two or more data blocks are based on the burst length extension and sizes of the two or more data blocks.

29. The method of claim 24, further comprising providing commands for closing one or more of the two or more data blocks to be activated based on the variable length command, before the variable length command is fully transmitted by the processor subsystem.

30. The method of claim 24, wherein the memory subsystem comprises a dynamic random access memory (DRAM).
